(19) United States
(12) Patent Application Publication
(10) Pub. No.: US 2018/0072196 A1
(43) Pub. Date: Mar. 15, 2018

(54) INTEGRATION OF A DEVICE IN A MOTOR VEHICLE SEAT ELEMENT

(71) Applicant: Faurecia Sieges D'Automobile, Nanterre (FR)

(72) Inventors: Jean-Marie MAUFFREY, VALDORE (FR); Quentin PARRAIN, LUXEUIL LES BAINS (FR); Mathieu BOQUET, VERRIERES LE BUISSON (FR)

(21) Appl. No.: 15/689,939

(22) Filed: Aug. 29, 2017

(30) Foreign Application Priority Data
Sep. 9, 2016 (FR) 16/58441

(51) Int. Cl. B60N 2/28; B60N 2/70; B29C 44/12; B29C 47/00

(52) U.S. Cl. CPC B60N 2/2881; B60N 2/7017; B32B 5/20; B29C 47/0042; B29C 44/1219

(57) ABSTRACT

A method of integrating a device in upholstery of a foam seat element, including the steps of: placing the device in a plastic bag or surrounding it with a plastic film; placing the assembly in an injection mold; and injecting foam to form the seat element in one piece.

This application claims the priority benefit of French patent application number 16/58441, the content of which is hereby incorporated by reference in its entirety to the maximum extent allowable by law.

### BACKGROUND

The present disclosure generally relates to motor vehicle seats and, more particularly, to the integration of a device in upholstery of a seat element made of foam.

### DISCUSSION OF THE RELATED ART

It is more and more often desired to integrate in seat elements a variety of devices or fittings. For example, headrests integrate mechanisms for adjusting the height of the headrest, seat bottom pieces or backrests integrate presence, temperature, and the like sensors.

Such an integration may be a problem, in particular when the seat element is formed by injection of foam into a mold. Indeed, the device cannot be placed in the mold before the foam injection since, during the injection, foam might reach portions of the device and hinder its subsequent operation.

There is a need to integrate a device in a foam seat element, with no risk of damaging the device.

### SUMMARY

An embodiment aims at providing a method of integrating a device in a seat element which overcomes all or part of the disadvantages of usual methods.

An embodiment provides a solution particularly adapted to the integration of a headrest mechanism in a foam headrest.

An embodiment provides an embodiment particularly adapted to presence sensors in a seat bottom piece or backrest.

Thus, an embodiment provides a method of integrating a device in upholstery of a foam seat element comprising the steps of: placing the device in a plastic bag or surrounding it with a plastic film; placing the assembly in an injection mold; and injecting foam to foam the seat element in one piece.

According to an embodiment, the foam coats the bag or the plastic film.

According to an embodiment, the bag or film is made of a material selected from among polyurethane, linear low-density polyethylene, and low-density polyethylene.

According to an embodiment, the bag or film is made of a mixture of polyethylene and starch.

According to an embodiment, the device is connected to the outside of the seat element.

According to an embodiment, a cover is placed at the bottom of the mold before injection.

According to an embodiment, the device is at least partially coated with a foam layer before being placed in the bag or film.

Another embodiment provides a seat element upholstery, integrating a device in foam formed in one piece.

According to an embodiment, the upholstery is obtained by implementing the previously-described method.

Another embodiment provides a seat element for a motor vehicle, comprising the previously-described upholstery.

According to an embodiment, the motor vehicle seat comprises at least one previously-described seat element.

The foregoing and other features and advantages will be discussed in detail in the following non-limiting description of dedicated embodiments in connection with the accompanying drawings.

### BRIEF DESCRIPTION OF THE DRAWINGS

FIG. 1 is a simplified representation of a device to be integrated in a motor vehicle seat element;

FIG. 2 is a simplified representation of a step preparatory to the integration of the device of FIG. 1 in a seat element;

FIG. 3 is a simplified perspective cross-section view of a foam injection mold to form a seat element;

FIG. 4 is a simplified representation of the seat element once completed;

FIG. 5 is a simplified perspective cross-section view of an example of application to the integration of a headrest mechanism; and

FIG. 6 is a cross-section view of an example of integration of a presence sensor in a seat bottom piece.

### DETAILED DESCRIPTION

For clarity, only those steps and elements which are useful to the understanding of the embodiments which will be described have been shown and will be detailed. In particular, the forming of the other seat elements, and particularly of the frame and of the cover, has not been detailed, the described embodiments being compatible with usual embodiments of such elements.

It should be noted that, in the drawings, the structural and/or functional elements common to the different embodiments may be designated with the same reference numerals and may have identical structural, dimensional, and material properties.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, it is referred, unless otherwise mentioned, to the orientation of the drawings or to a seat in its normal position of use. Unless otherwise specified, expressions approximately, substantially, and in the order of mean to within 10%, preferably to within 5%.

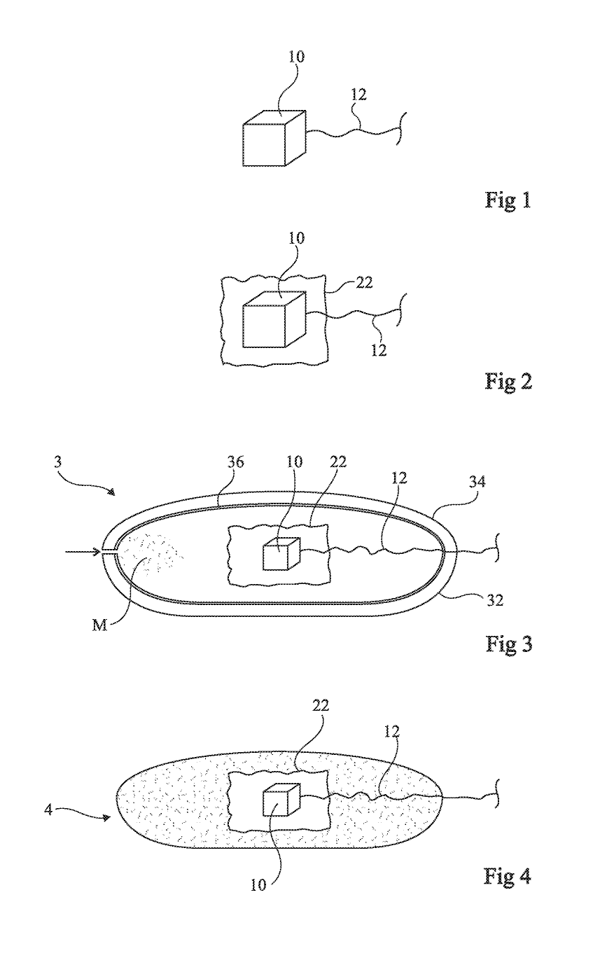

FIG. 1 very schematically shows a device 10 to be integrated in a seat element (not shown). Although device 10 is symbolized in the form of a cube, its shape depends on the application. It may for example be a headrest mechanism, a sensor of the presence of a passenger to be integrated in a seat bottom piece or a backrest, etc.

Device 10 may be connected to a wire or cable 12 enabling to exchange information with the outside of the seat element. According to another example, device 10 faults one piece with a rigid element intended to jut out from the seat element such as, for example, headrest rods.

Now, the integration of devices of the type of that in FIG. 1 in a seat element can only be performed afterwards, that is, the seat element is manufactured in the form of two foam shells which include a structural opening for the device. Such an opening is generally defined by the foam injection mold forming the two half-shells. Then, the device is placed in this space and finally the two shells are assembled. Such a process is long.

It is however not possible, with current techniques, to place the device in the injection mold, so as to form the element in one piece. Indeed, during the injection, due to pressure, foam would penetrate into the device and would risk adversely affecting its subsequent operation.

In the embodiments described hereafter, it is provided to place the device to be integrated in the seat element in a bag or a pocket to protect it from the foam during the injection. The foam injection and device integration operation can thus be carried out at once. Term “injection” is used, but it should be understood that when reference is made to an injection, this also comprises foam spraying techniques, and other foam foaming techniques.

FIG. 2 very schematically shows a step preparatory to the foam injection to form a seat element. Device 10 to be integrated is placed in a protective pocket or film 22. In the case of a device connected by a physical element to the outside (wire 12), this element crosses pocket or film 22. The function of film 22 is to protect the device during the foam injection and to avoid for foam to insert into parts of the device.

FIG. 3 is a simplified view of a foam injection mold 3 for forming a seat element. In this example, mold 3 is made of two parts 32 and 34 assembled to each other. Device 10, protected by its bag 22, is placed in mold 3 at the position desired for this device in its final position. Then, foam M is injected into mold 3 to form the seat element.

Preferably, a lining material 36 made of woven or nonwoven textile, of skin, or of a synthetic material is arranged, before the foam injection, at the bottom of mold 3 to directly form the cover around the upholstery.

FIG. 4 is a simplified representation of the seat element once completed.

Once the foam has polymerized, the seat element is taken out of the mold and this element 4 integrating device 10 is obtained.

An advantage is that it is now possible to form a seat element in one piece by foam injection, including while integrating a device inside of it. The manufacturing is considerably simplified.

The material of bag or film 22 is selected to be foam-tight during the injection to protect device 10 from any contact with the foam being injected. Once the foam has polymerized, it forms a shell around the device.

According to an embodiment, film or bag 22 is made of plastic, for example, of polyurethane, of linear low-density polyethylene (LLDPE), of low-density polyethylene (LDPE). According to this embodiment, this bag or film 22 remains once the element has been completed.

According to another embodiment, film or bag 22 is made of a material which degrades once the foam has polymerized. It is, for example, a film or bag made up of polyethylene and starch, which has the specificity of disappearing when the foam polymerizes or, more specifically, of integrating to the foam. Such an embodiment is particularly adapted to devices for which it is feared that the permanent presence of a plastic bag around the device adversely affects their operation. This is for example true for devices such as sensors where the presence of the bag may adversely affect the sensor sensitivity or the transmission of measurements in the case of a wireless transmission.

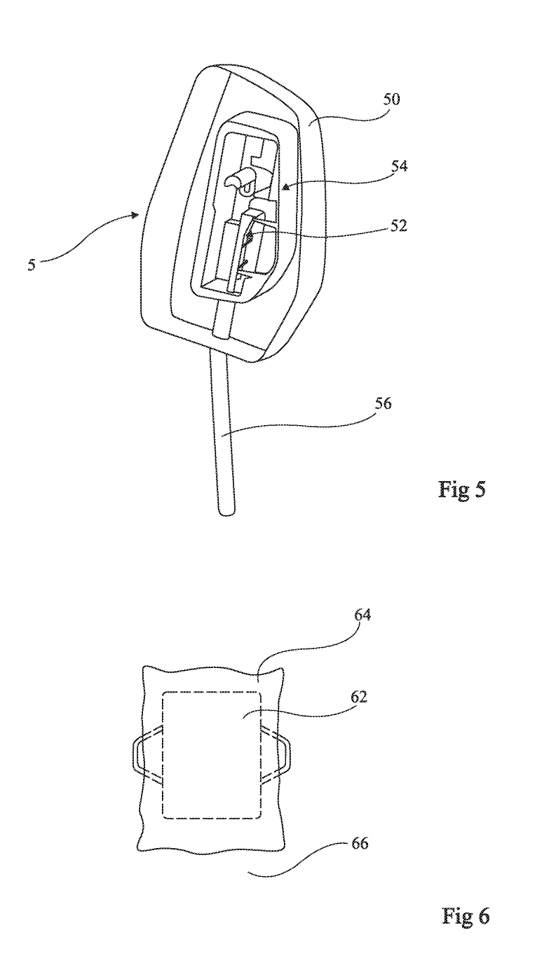

FIG. 5 is a simplified perspective cross-section view of an example of application to the integration of a headrest mechanism 5 in a foam headrest.

For simplification, the foam has not been shown in FIG. 5 and it is a symbolic representation.

The outside of the headrest is defined by a cover or cover element 50, for example, arranged at the bottom of the mold before the injection. As a variation, cover 50 is placed on the molded foam. Headrest mechanism 52 is placed in a plastic bag 54. Foam is injected between cover 50 and bag 54. In the example of a headrest, rods 56 are connected to the mechanism and thus cross pocket 54 and cover 50.

FIG. 6 is a cross-section view of an example of a presence sensor 62 to be integrated in a seat bottom piece (not shown).

Here, sensor 62 is placed in a bag 64, preferably made of a material which is degradable during the foam polymerization. However, according to this embodiment, a reinforced textile part 66 is also used to protect the sensor on the cover side. This textile part may be the actual cover.

An advantage of the embodiments which have been described is that it is possible to integrate a device in a seat element, including in a method of forming the seat element in one piece of foam.

Another advantage is that, according to the material selected for the film or bag, the latter may disappear and have no influence on the subsequent operation.

Various embodiments have been described. Various alterations, modifications, and improvements will occur to those skilled in the art. In particular, the forming of the actual foam has not been discussed, the described embodiments being per se compatible with usual forming methods. For example, the device is at least partially coated with a foam layer before being placed in the bag or film. Further, the practical implementation of the described embodiments is within the abilities of those skilled in the art based on the functional indications given hereabove, be it for molding techniques or for the selection of the material forming the bag or film.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method of integrating a device in upholstery of a foam seat element comprising the steps of:
placing the device in a plastic bag or surrounding it with a plastic film;
placing the assembly in an injection mold; and
injecting foam to form the seat element in one piece.

2. The method of claim 1, wherein the foam coats the plastic bag or film.

3. The method of claim 1, wherein the bag or film is made of a material selected from among polyurethane, linear low-density polyethylene, and low-density polyethylene.

4. The method of claim 1, wherein the bag or film is made of a mixture of polyethylene and of starch.

5. The method of claim 1, wherein the device is connected to the outside of the seat element.

6. The method of claim 1, wherein a cover is placed at the bottom of the mold before the injection.

7. The method of claim 1, wherein the device is at least partially coated with a foam layer before being placed in the bag or film.

8. Upholstery of a seat element, integrating a device made of foam formed in one piece.

9. A motor vehicle seat element comprising the upholstery of claim 8.

10. A motor vehicle seat comprising at least one seat element of claim 9.

11. Upholstery of a seat element, integrating a device made of foam formed in one piece, wherein the upholstery is obtained by implementing the method of claim 1.
